(19) United States
(12) Patent Application Publication
(10) Pub. No.: US 2018/0085787 A1
(43) Pub. Date: Mar. 29, 2018

(54) RBAR DEVICE INCLUDING AT LEAST ONE AIR-RING

(71) Applicant: Avago Technologies General IP (Singapore) Pte. Ltd., Singapore (SG)

(72) Inventors: Dariusz Burak, Fort Collins, CO (US); Stefan Bader, Fort Collins, CO (US); Kevin J. Grannen, Thornton, CO (US)

(21) Appl. No.: 15/280,866

(22) Filed: Sep. 29, 2016

(51) Int. Cl. B06B 1/06

(52) U.S. Cl. CPC B06B 1/0644

(57) ABSTRACT

A reversed c-axis bulk acoustic resonator (RBAR) device includes a bottom electrode disposed over a substrate and at least a portion of a cavity formed in the substrate; a first piezoelectric layer disposed over the bottom electrode, the first piezoelectric layer having a first polarity; a middle electrode disposed over the first piezoelectric layer; a second piezoelectric layer disposed over the bottom electrode, the second piezoelectric layer having a second polarity that is substantially opposite to the first polarity of the first piezoelectric layer; and a top electrode disposed over the second piezoelectric layer. The RBAR device further includes at least one air-ring formed between the top electrode and the second piezoelectric layer, between the second piezoelectric layer and the middle electrode, between the middle electrode and the first piezoelectric layer, or between the first piezoelectric layer and the bottom electrode.

### BACKGROUND

Acoustic transducers generally convert electrical signals to acoustic signals (sound waves) and convert received acoustic waves to electrical signals via inverse and direct piezoelectric effect. There are a number of types of acoustic transducers including acoustic resonators, such as bulk acoustic wave (BAW) resonators. BAW resonators may be used for electrical filters and voltage transformers, for example, in a wide variety of electronic applications, such as cellular telephones, personal digital assistants (PDAs), electronic gaming devices, laptop computers and other portable communications devices. BAW resonators, in particular, include thin film bulk acoustic resonators (FBARs), which generally have acoustic stacks formed over a substrate cavity, and solidly mounted resonators (SMRs), which generally have acoustic stacks formed over an acoustic mirror (e.g., a distributed Bragg reflector (DBR)).

BAW resonators also include resonators having more than two electrodes, such as double bulk acoustic resonator (DBAR) and reversed c-axis bulk acoustic resonator (RBAR) devices, which have three electrodes (bottom, middle and top electrodes) with a first piezoelectric layer formed between the bottom and middle electrodes and a second piezoelectric layer formed between the middle and top electrodes, over an acoustic resonator, such as a cavity or an acoustic mirror. An RBAR, in particular, is a “mix” between DBAR and FBAR devices. However, the first and second piezoelectric layers of an RBAR device have opposite polarities, as discussed with reference to FIGS. 1A and 1B, which are perspective views of illustrative models of common wurtzite structures of piezoelectric materials (e.g., aluminum nitride (AlN)). Generally, polarization of the piezoelectric material is defined as being in the “positive direction” from cation (e.g., Al atoms) to anion (e.g., N atoms) along the crystallographic axis points. Accordingly, as shown in FIG. 1A, when the first layer of the crystal lattice 100A is an Al layer and the second layer in an upward direction (in the depicted orientation) is an N layer, the piezoelectric material including the crystal lattice 100A is said to have “positive polarity” along the c-axis (or “CP”), as indicated by the upward pointing arrow 150A. Conversely, as shown in FIG. 1B, when the first layer of the crystal lattice 100B is an N layer and second layer in an upward direction is an Al layer, the piezoelectric material including the crystal lattice 100B is said to have “negative polarity” along the c-axis (or “CN”), as indicated by the downward pointing arrow 150B. Notably, the more standard convention for RBAR devices is for the first piezoelectric layer to have a negative polarity and the second piezoelectric layer to have a positive polarity.

RBAR devices advantageously reduce the resonator area of the resonator device by 3 to 4 times as compared to an FBAR, and by 1.5 to 2 times as compared to a DBAR. This feature is desirable for BAW resonators functioning in low-band frequency ranges, for example. Also, like an FBAR, an RBAR operates in the first harmonic providing advantages in quality factor Q (Q-factor) as compared to a DBAR, for example, which operates in the second harmonic. However, further improvement in Q-factor, while maintaining or increasing structural strength and performance efficiency, is desirable for RBAR devices.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a perspective view of an illustrative model of a crystal structure of aluminum nitride (AlN) in piezoelectric material having positive polarization.

FIG. 1B is a perspective view of an illustrative model of a crystal structure of AlN in piezoelectric material having negative polarization.

FIG. 2A is a simplified cross-sectional view of an RBAR device with an air-ring, including an air-bridge and an air-wing, between a top electrode and a second piezoelectric layer, according to a representative embodiment.

FIG. 2B is a simplified cross-sectional view of an RBAR device with an air-ring between a second piezoelectric layer and a middle electrode, according to a representative embodiment.

FIG. 2C is a simplified cross-sectional view of an RBAR device with an air-ring between a middle electrode and a first piezoelectric layer, according to a representative embodiment.

FIG. 2D is a simplified cross-sectional view of an RBAR device with an air-ring between a first piezoelectric layer and a bottom electrode, according to a representative embodiment.

FIG. 3A is a simplified cross-sectional view of an RBAR device with multiple air-rings, according to a representative embodiment.

FIG. 3B is a simplified cross-sectional view of an RBAR device with multiple air-rings, according to a representative embodiment.

FIG. 3C is a simplified cross-sectional view of an RBAR device with multiple air-rings, according to a representative embodiment.

FIG. 4A is a simplified cross-sectional view of an RBAR device with multiple air-rings, according to a representative embodiment.

FIG. 4B is a simplified cross-sectional view of an RBAR device with multiple air-rings, according to a representative embodiment.

FIG. 4C is a simplified cross-sectional view of an RBAR device with multiple air-rings, according to a representative embodiment.

FIG. 5 is a simplified cross-sectional view of an RBAR device with an air-ring, according to a representative embodiment.

### DETAILED DESCRIPTION

It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a”, “an” and “the” include both singular and plural referents, unless the context clearly dictates otherwise. Thus, for example, “a device” includes one device and plural devices. Also, the terms “a resonator” and “a resonator device,” may be used interchangeably, according to the context of the disclosure. As used in the specification and appended claims, and in addition to their ordinary meanings, the terms “substantial” or “substantially” mean to within acceptable limits or degree. For example, “substantially cancelled” means that one skilled in the art would consider the cancellation to be acceptable. As used in the specification and the appended claims and in addition to its ordinary meaning, the term “approximately” or “about” means to within an acceptable limit or amount to one of ordinary skill in the art. For example, “approximately the same” means that one of ordinary skill in the art would consider the items being compared to be the same.

In the following detailed description, for purposes of explanation and not limitation, specific details are set forth in order to provide a thorough understanding of illustrative embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the illustrative embodiments. Such methods and apparatuses are clearly within the scope of the present teachings.

Generally, it is understood that the drawings and the various elements depicted therein are not drawn to scale. Further, relative terms, such as “above,” “below,” “top,” “bottom,” “upper” and “lower” are used to describe the various elements' relationships to one another, as illustrated in the accompanying drawings. It is understood that these relative terms are intended to encompass different orientations of the device and/or elements in addition to the orientation depicted in the drawings. For example, if the device were inverted with respect to the view in the drawings, an element described as “above” another element, for example, would now be below that element.

Aspects of the present teachings are relevant to components of BAW resonator devices and filters, their materials and their methods of fabrication. Various details of such devices and corresponding methods of fabrication may be found, for example, in one or more of the following U.S. patent publications: U.S. Pat. No. 6,107,721 to Lakin; U.S. Pat. Nos. 5,587,620, 5,873,153, 6,507,983, 6,384,697, 7,275,292, 7,629,865 and 7,388,454 to Ruby et al.; U.S. Pat. No. 7,280,007 to Feng, et al.; U.S. Pat. No. 8,981,876 to Jamneala et al.; U.S. Patent App. Pub. Nos. 2010/0327697 and 2010/0327994 to Choy et al.; and U.S. Patent App. Pub. Nos. 2011/0180391 and 2012/0177816 to Larson, et al. The disclosures of these patents and patent applications are hereby specifically incorporated by reference in their entireties. It is emphasized that the components, materials and method of fabrication described in these patents and patent applications are representative and other methods of fabrication and materials within the purview of one of ordinary skill in the art are contemplated.

Generally, according to various embodiments, reversed c-axis bulk acoustic resonator (RBAR) devices have lateral performance enhancement features (lateral energy confinement features), such as inner and outer frames on the top electrode, as well as single or double air-rings embedded in the structure, to improve electrical and acoustic performance. Also, when at least one air-ring is below the middle electrode of the RBAR, the various embodiments enable the middle and bottom electrodes to extend beyond all outer edges of the acoustic reflector (e.g., air-cavity), thereby enhancing structural strength and reducing (including possibly eliminating) parasitic transducer effect (sometimes referred to as “dead-FBAR”) in the RBAR. Reducing the parasitic transducer effect, in particular, generally leads to recovered baseline Q-factor values.

According to a representative embodiment, an RBAR device includes a bottom electrode disposed over a substrate and at least a portion of a cavity formed in the substrate; a first piezoelectric layer disposed over the bottom electrode, the first piezoelectric layer having a first polarity; a middle electrode disposed over the first piezoelectric layer; a second piezoelectric layer disposed over the bottom electrode, the second piezoelectric layer having a second polarity that is substantially opposite to the first polarity of the first piezoelectric layer; and a top electrode disposed over the second piezoelectric layer. The RBAR device further includes at least one air-ring, which may be formed between the top electrode and the second piezoelectric layer, between the second piezoelectric layer and the middle electrode, between the middle electrode and the first piezoelectric layer, or between the first piezoelectric layer and the bottom electrode.

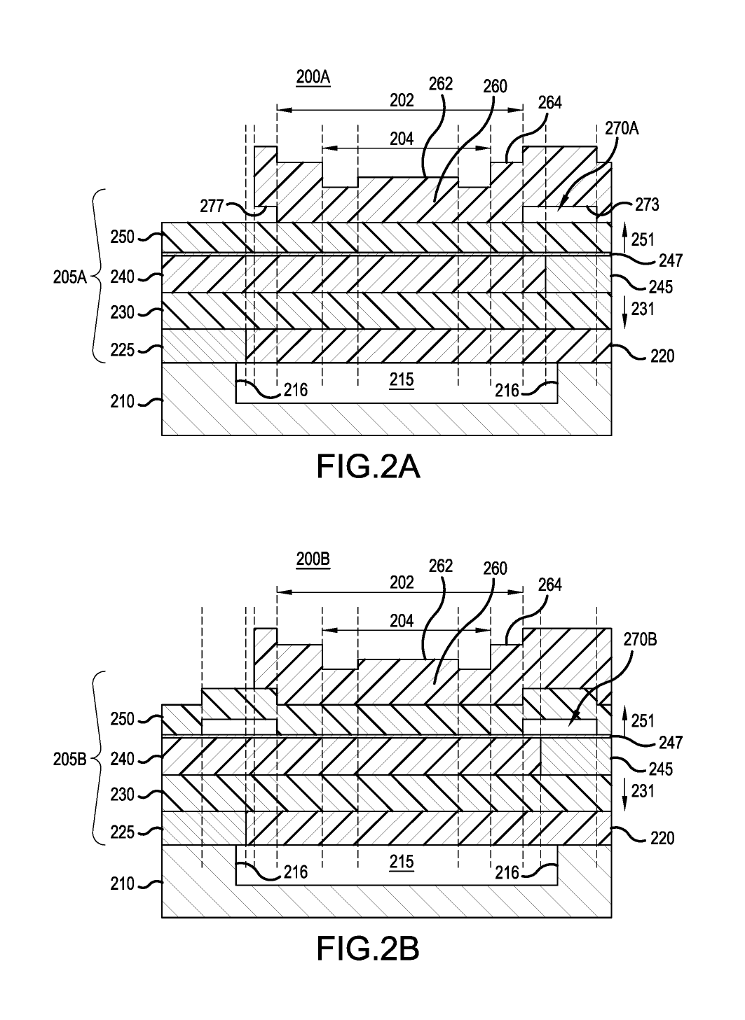

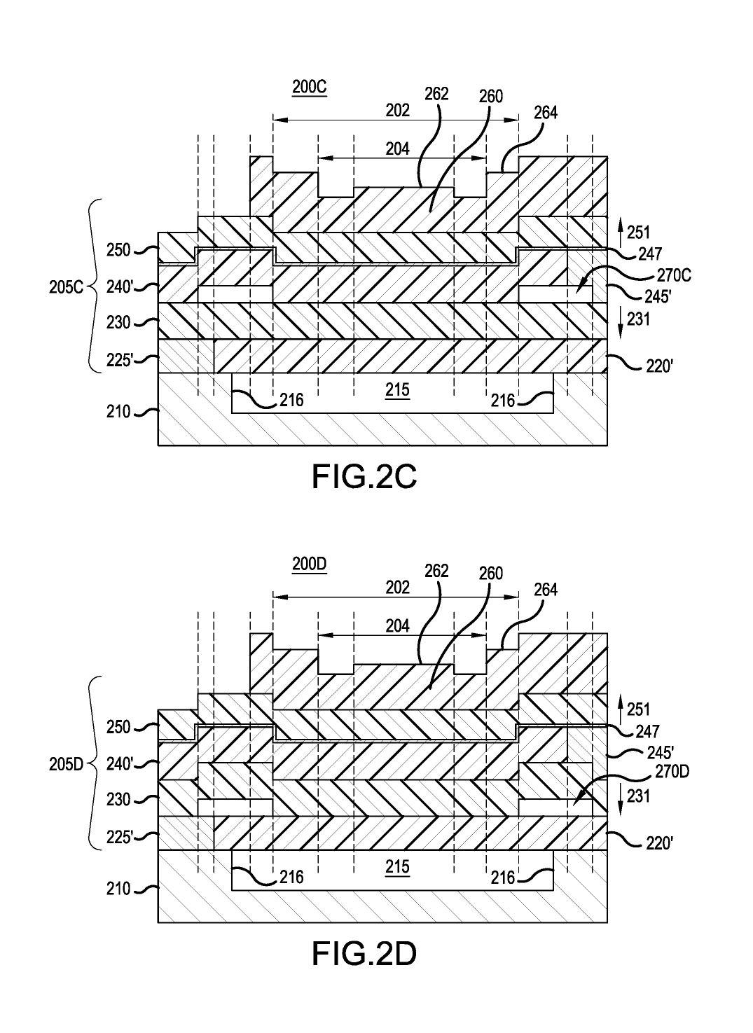

FIGS. 2A to 2D are simplified cross-sectional diagrams of RBAR devices with an air-ring, according to representative embodiments.

Referring to FIG. 2A, RBAR device 200A includes a substrate 210 defining a cavity 215 (e.g., an air cavity), which functions as the acoustic reflector. A bottom electrode 220 and an adjacent planarization layer 225 are formed (or disposed) over the substrate 210 and the cavity 215, a first piezoelectric layer 230 is formed over the bottom electrode 220 and planarization layer 225, a middle electrode 240 and an adjacent planarization layer 245 are formed over the first piezoelectric layer 230, a second piezoelectric layer 250 is formed over the middle electrode 240 and the planarization layer 245, and a top electrode 260 is formed over the second piezoelectric layer 250, collectively forming an acoustic stack 205A. A passivation layer (not shown) may be formed over the top electrode 260. The passivation layer generally insulates the acoustic stack 205A from the environment, including protection from moisture, corrosives, contaminants, debris and the like. Further, in the depicted embodiment, a thin dielectric seed layer 247 is formed over the middle electrode 240 and the planarization layer 245, and the second piezoelectric layer 250 is grown on the dielectric seed layer 247 in order to reverse the polarity of the second piezoelectric layer 250, as discussed below.

In addition, the RBAR device 200A includes various performance enhancement features, including inner frame 262 and outer frame 264 provided on a top surface of the top electrode 260, as well as air-ring 270A formed between the top electrode 260 and the second piezoelectric layer 250. In the depicted embodiment, the air-ring 270A comprises an air-bridge 273 and an air-wing 277. The air-bridge 273 is located on the connection side of the top electrode 260 and the air-wing 277 is located along the remaining outside perimeter (around an outer perimeter of the top electrode 260). Because RBARs operate in the first harmonic, these lateral performance enhancement features improve the Q-factor of the RBAR device 200A. This differs from a DBAR device, for example, for which frames and air-rings are not particularly effective due to the approximately twice as many higher order lateral modes supported by the DBAR stack that need to be simultaneously suppressed. As mentioned above, the inner frame 262, the outer frame 264 and the air-ring 270A generally increase the Q-factor of the BAW resonator device, while at least maintaining the desired coupling coefficient kt². Although the air-ring 270A, and corresponding air-gaps formed by air-bridge 273 and air-wing 277 of the air-ring 270A, are shown with rectangular shaped cross-sections, these structures may have other shapes, such as trapezoidal cross-sectional shapes, without departing from the scope of the present teachings. Examples of configurations, dimensions, alternative shapes, and the like with regard to air-bridges and/or air-wings are described and illustrated in U.S. Patent Application Publication No. 2012/0218057 (published Aug. 30, 2012) to Burak et al., U.S. Patent Application Publication No. 2010/0327697 (published Dec. 30, 2010) to Choy et al.; and U.S. Patent Application Publication No. 2010/0327994 (published Dec. 30, 2010) to Choy et al., the disclosures of which are hereby incorporated by reference in their entireties.

An overlap among the bottom electrode 220, the first piezoelectric layer 230, the middle electrode 240, the second piezoelectric layer 250 and the top electrode 260 over the cavity 215 defines a main membrane region 202 of the RBAR device 200A (as well as the other RBAR devices disclosed herein). Here, an overlap means the region where the bottom electrode 220, the first piezoelectric layer 230, the middle electrode 240, the second piezoelectric layer 250 and the top electrode 260 are mechanically attached to each other in the vertical direction. In the embodiment depicted in FIG. 2A, the outer edges of the top electrode 260 correspond to the inner edges of the air-bridge 273 and the air-wing 277 of the air-ring 270A. The other embodiments disclosed herein similarly indicate the outer edges of the top electrode 260, and thus the boundaries of the main membrane 202, by the inner edges of corresponding air-ring(s). Dotted vertical lines indicate the boundary of the main membrane region 202 in each of the RBAR devices.

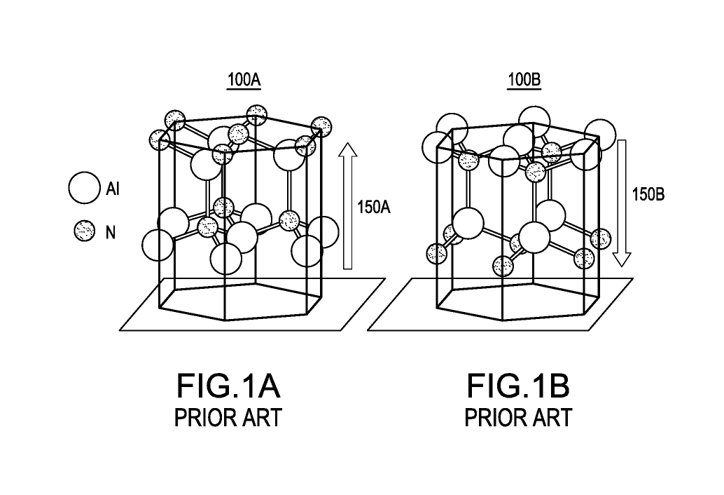

The first and second piezoelectric layers 230 and 250 in the acoustic stack 205A of the RBAR device 200A (as well as the RBAR devices in the other embodiments discussed below) may be formed of various materials, such as aluminum nitride (AlN), zinc oxide (ZnO), or lead zirconate titanate (PZT), for example. Also, the relative thicknesses may vary to provide unique benefits for any particular situation or to meet application specific design requirements of various implementations, as would be apparent to one skilled in the art. For purposes of illustration, it is assumed that first and second piezoelectric layers 230 and 250 are each formed of AlN, since AlN generally maintains piezoelectric properties at high temperatures (e.g., above 400° C.), and have substantially the same thicknesses. The AlN thin film is typically grown in a c-axis orientation perpendicular to the top surface of the substrate 210 using reactive magnetron sputtering, for example. Also, AlN thin film may be deposited with various specific crystal orientations, including a wurtzite (0001) B4 structure consisting of a hexagonal crystal structure with alternating layers of Al and N, as discussed above with reference to FIGS. 1A and 1B.

In the depicted embodiment, the first piezoelectric layer 230 has a negative polarity (indicated by downward pointing arrow 231), and the second piezoelectric layer 250 has a positive polarity (indicated by upward pointing arrow 251). The negative polarity may be referred to as “regular c-axis” or “CN,” and is directed substantially toward the bottom electrode 220. The positive polarity may be referred to as “reversed c-axis” or “CP,” and is directed substantially away from the bottom electrode 220. In order to obtain the reversed c-axis orientation of the second piezoelectric layer 250, a thin dielectric seed layer 247 comprising a dielectric material, e.g., such as aluminum oxynitride (AlON, or oxide), is disposed over the top surfaces of the middle electrode 240 and the planarization layer 245, as mentioned above, and the second piezoelectric layer 250 is grown on the dielectric seed layer 247.

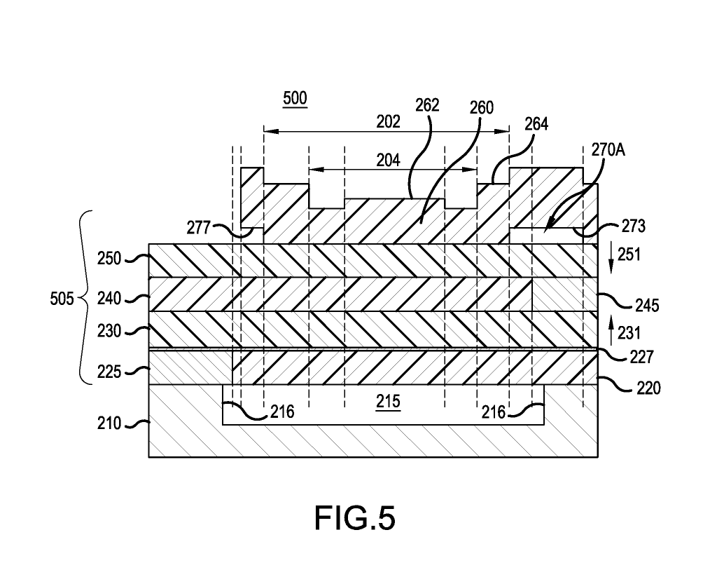

An alternative embodiment may include the first piezoelectric layer 230 having a positive polarity, and the second piezoelectric layer 250 having a negative polarity. In this case, a thin dielectric seed layer, e.g., AlON or oxide, is disposed over the top surfaces of the bottom electrode 220 and the planarization layer 225, and the first piezoelectric layer 230 is grown on the dielectric seed layer. As an example, FIG. 5 is a simplified cross-sectional view of an RBAR device 500, according to a representative embodiment, that is substantially the same as the RBAR device 200A in FIG. 2A, except that it includes a thin dielectric layer 227 formed over the bottom electrode 220 and the planarization layer 225 (and no thin dielectric layer 247). The first piezoelectric layer 230 is grown on the dielectric seed layer 227, reversing the polarity of the first piezoelectric layer 230. Thus, in the depicted embodiment, the first piezoelectric layer 230 has a positive polarity (indicated by upward pointing arrow 231), and the second piezoelectric layer 250 has a negative polarity (indicated by downward pointing arrow 251). It is understood that the dielectric seed layer may be applied to the bottom electrode (220, 220′) and the planarization layer (225, 225′) in any of the various embodiments discussed herein (e.g., referencing FIGS. 2B-2D, 3A-3C and 4A-4C), in the same manner as shown in FIG. 5, in order to provide reversed c-axis orientation in first piezoelectric layer 230, as opposed to the second piezoelectric layer 250. Piezoelectric layers formed of AlN and having different crystal orientations (e.g., substantially opposite crystal orientations) are described, for example, by U.S. patent application Ser. No. 15/253,527 to Burak et al. (filed Aug. 31, 2016), which is hereby incorporated by reference in its entirety.

The substrate 210 may be formed of various materials compatible with semiconductor processes, such as silicon (Si), gallium arsenide (GaAs), indium phosphide (InP), or the like. Various illustrative fabrication techniques for forming an air cavity in a substrate are described by Grannen et al., U.S. Pat. No. 7,345,410 (issued Mar. 18, 2008), which is hereby incorporated by reference in its entirety. The bottom, middle and top electrodes 220, 240 and 260 are formed of electrically conductive material(s), such as molybdenum (Mo) or tungsten (W), and the passivation layer may be formed of a passivation material, such as silicon dioxide (SiO₂) or silicon nitride (Si₃N₄), for example, although other materials compatible for use with BAW resonator electrodes and passivation may be incorporated, without departing from the scope of the present teachings. One or more of the bottom, middle and top electrodes 220, 240 and 260 may be formed of the same or different electrically conductive material(s) from one another, and/or the bottom, middle and top electrodes 220, 240 and 260 may be substantially the same or different thicknesses from one another, to provide unique benefits for any particular situation or to meet application specific design requirements of various implementations, as would be apparent to one skilled in the art.

Referring to FIG. 2B, RBAR device 200B includes substrate 210 defining cavity 215. Bottom electrode 220 and adjacent planarization layer 225 are formed over the substrate 210 and the cavity 215, first piezoelectric layer 230 is formed over the bottom electrode 220 and planarization layer 225, middle electrode 240 and adjacent planarization layer 245 are formed over the first piezoelectric layer 230, thin dielectric seed layer 247 is formed over the middle electrode 240 and the planarization layer 245, second piezoelectric layer 250 is formed over the dielectric seed layer 247, and top electrode 260 is formed over the second piezoelectric layer 250, collectively forming acoustic stack 205B. A passivation layer (not shown) may be formed over the top electrode 260.

In addition, the RBAR device 200B includes various performance enhancement features, including inner frame 262 and outer frame 264 provided on the top surface of the top electrode 260, as well as air-ring 270B formed between the second piezoelectric layer 250 and the middle electrode 240 (and the planarization layer 245). In the depicted embodiment, the air-ring 270B does not include an air-wing since the air space formed by the air-ring 270B is entirely enclosed within the acoustic stack 205B. As discussed above, these lateral performance enhancement features improve the Q-factor of the RBAR device 200B, while at least maintaining the desired coupling coefficient kt².

In FIGS. 2A and 2B, the respective air-rings 270A and 270B are formed above the middle electrode 240. Therefore, the air-rings 270A and 270B do not reduce parasitic transducer effect despite the presence of the air-rings 270A and 270B, respectively. The parasitic transducer effect occurs when the middle electrode 240, the first piezoelectric layer 230 and the bottom electrode 220 overlap with the substrate 210. In such a configuration, electrical excitation of the first piezoelectric layer 230 by the middle and the bottom electrodes 240 and 220, respectively, may produce bulk acoustic waves that may propagate into the substrate 210, resulting in detrimental energy loss and reduction of the Q-factor. Thus, in order to reduce the parasitic transducer effect in these embodiments, each of the bottom electrode 220 and the middle electrode 240 of the RBAR devices 200A and 200B is terminated over the cavity 215 (or other acoustic reflector) formed in the substrate 210, and is planarized. That is, the bottom electrode 220 ends within outer edges 216 of the cavity 215 (shown on the left side of the RBAR devices 200A, 200B in the depicted orientation), and thus is not in contact with the substrate 210 on all sides of the cavity 215. Likewise, the middle electrode 240 ends within the outer edges 216 of the cavity 215 (shown on the right side of the RBAR devices 200A, 200B in the depicted orientation). This configuration of the bottom electrode 220 and the middle electrode 240 avoids the parasitic transducer effect, while retaining advantages of the air-rings 270A and 270B.

Referring to FIG. 2C, RBAR device 200C includes substrate 210 defining cavity 215. Bottom electrode 220′ and adjacent planarization layer 225′ are formed over the substrate 210 and the cavity 215, first piezoelectric layer 230 is formed over the bottom electrode 220′ and planarization layer 225′, middle electrode 240′ and adjacent planarization layer 245′ are formed over the first piezoelectric layer 230, second piezoelectric layer 250 is formed over the middle electrode 240′ and the planarization layer 245′, and top electrode 260 is formed over the second piezoelectric layer 250, collectively forming acoustic stack 205C. Referring to FIG. 2D, bottom electrode 220′ and adjacent planarization layer 225′ are formed over the substrate 210 and the cavity 215, first piezoelectric layer 230 is formed over the bottom electrode 220′ and planarization layer 225′, middle electrode 240′ and adjacent planarization layer 245′ are formed over the first piezoelectric layer 230, second piezoelectric layer 250 is formed over the middle electrode 240′ and the planarization layer 245′, and top electrode 260 is formed over the second piezoelectric layer 250, collectively forming acoustic stack 205D. In each of the depicted embodiments, dielectric seed layer 247 is formed over the middle electrode 240′ and the planarization layer 245′, and the second piezoelectric layer 250 is grown on the dielectric seed layer 247 in order to reverse the polarity of the second piezoelectric layer 250. A passivation layer (not shown) may be formed over the top electrode 260 of each of the RBAR devices 200C and 200D.

In addition, the RBAR devices 200C and 200D include various performance enhancement features, including inner frame 262 and outer frame 264 provided on the top surface of the top electrode 260. The RBAR device 200C further includes air-ring 270C formed between middle electrode 240′ (and the planarization layer 245′) and the first piezoelectric layer 230, and the RBAR device 200D further includes air-ring 270D formed between the first piezoelectric layer 230 and the bottom electrode 220′ (and the planarization layer 225′). In the depicted embodiments, the air-rings 270C and 270D do not include air-wings since the respective air spaces are entirely enclosed within the acoustic stacks 205C and 205D.

As discussed above, these lateral performance enhancement features improve the Q-factors of the RBAR devices 200C and 200D, respectively, while at least maintaining the desired coupling coefficient kt². In addition, because each of the air-rings 270C and 270D is formed between adjacent layers situated below the second piezoelectric layer 250, they reduce the parasitic transducer effect otherwise present in RBAR devices. That is, the air-ring 270C is between the middle electrode 240′ (and planarization layer 245′) and the first piezoelectric layer 230, and the air-ring 270D is between the first piezoelectric layer 230 and bottom electrode 220′ (and planarization layer 225′). Accordingly, there is no need for the middle electrode 240′ and/or the bottom electrode 220′ to end within outer edges 216 of the cavity 215, and are therefore longer than the middle electrode 240 and the bottom electrode 220, respectively, discussed above (but otherwise have the same characteristics). Therefore, in the embodiments depicted in FIGS. 2C and 2D, no portion of the middle electrode 240′ and/or the bottom electrode 220′ ends within the outer edges 216 of the cavity 215.

Referring to the bottom electrode 220′, in particular, by extending entirely across the cavity 215 (i.e., all outer edges of the bottom electrode 220′ are over and/or in physical contact with the top surface of the substrate 210), structural strength of the RBAR device 200C, 200D is increased, and heat transfer from the acoustic stack 205C, 205D to the substrate 210 is also increased. The additional structural strength and increased heat transfer enhance performance of the RBAR devices 200C and 200D, as compared for example to RBAR devices with air-rings formed between layers at or above the second piezoelectric layer 250, such as RBAR devices 200A and 200B.

As a general rule from the material structural quality point of view, the higher an air-ring is located in an acoustic stack, the better for the other layers in the acoustic stack. For example, crack(s) may form in a layer deposited over sacrificial material used to ultimately form an air-ring, and corresponding crack(s) may appear in the stacked layers above. Therefore, the structure of the RBAR device 200C is the highest relative location the air-ring (air-ring 270C) may be in the acoustic stack, while still reducing the parasitic transducer effect.

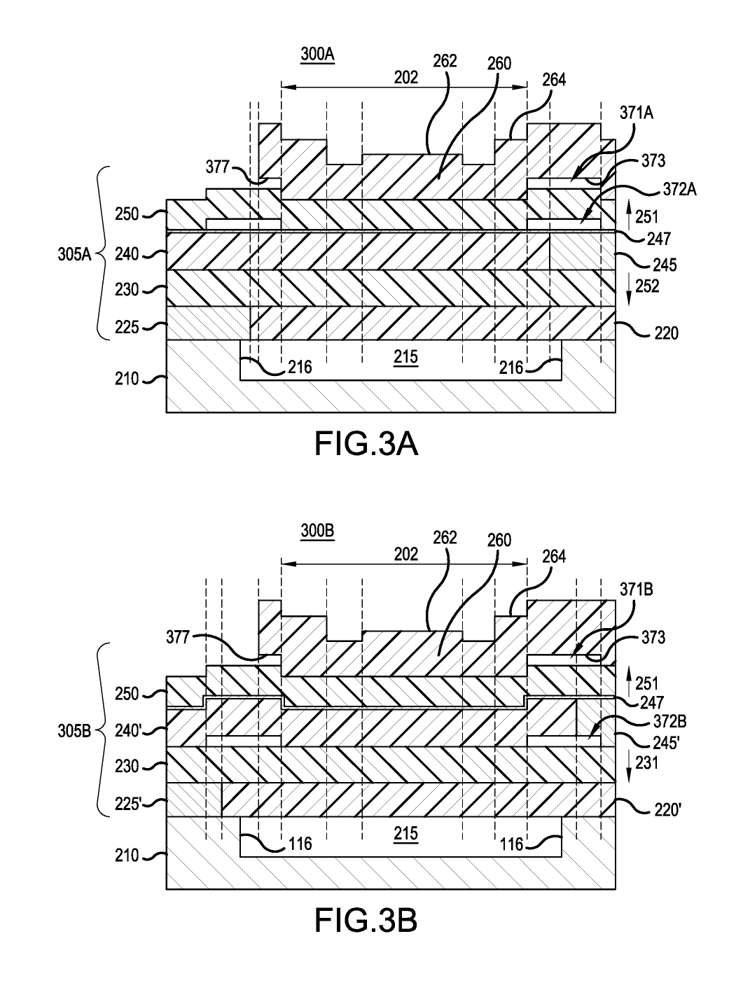

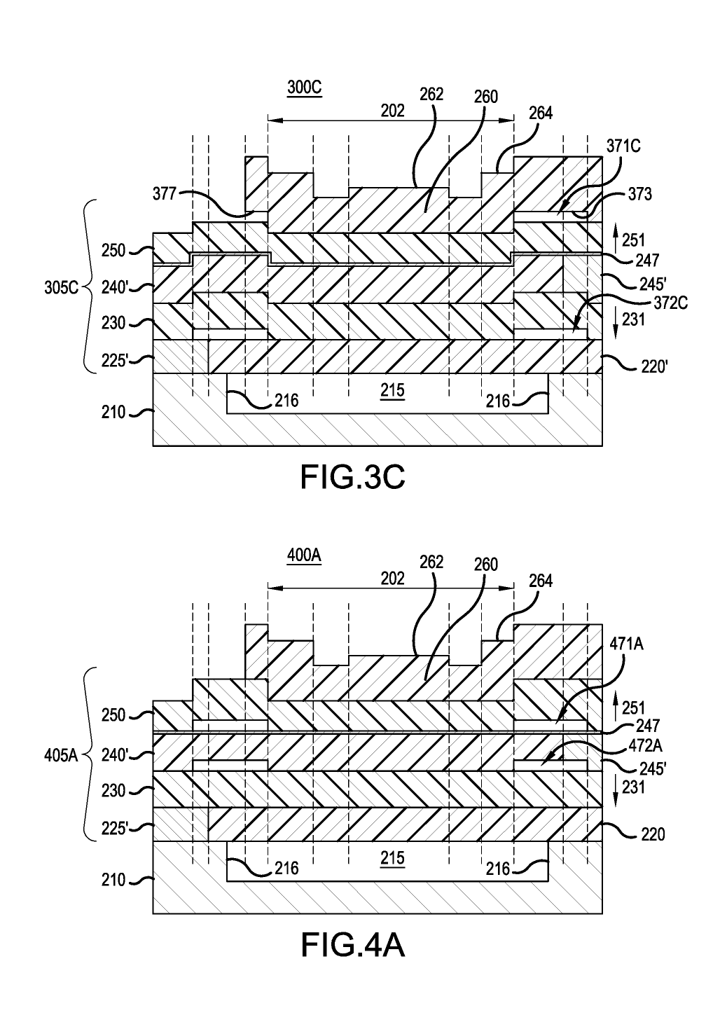

FIGS. 3A to 3C are simplified cross-sectional diagrams of RBAR devices with multiple air-rings, according to representative embodiments.

Referring to FIG. 3A, RBAR device 300A includes substrate 210 defining cavity 215. Bottom electrode 220 and adjacent planarization layer 225 are formed over the substrate 210 and the cavity 215, first piezoelectric layer 230 is formed over the bottom electrode 220 and planarization layer 225, middle electrode 240 and adjacent planarization layer 245 are formed over the first piezoelectric layer 230, second piezoelectric layer 250 is formed over the middle electrode 240 and the planarization layer 245, and top electrode 260 is formed over the second piezoelectric layer 250, collectively forming an acoustic stack 305A. In the depicted embodiment, dielectric seed layer 247 is formed over the middle electrode 240 and the planarization layer 245, and the second piezoelectric layer 250 is grown on the dielectric seed layer 247 to reverse the polarity of the second piezoelectric layer 250. A passivation layer (not shown) may be formed over the top electrode 260.

The RBAR device 300A includes various performance enhancement features, including inner frame 262 and outer frame 264 provided on top of the top electrode 260. The RBAR device 300A further includes two air-rings, first air-ring 371A and second air-ring 372A. The first air-ring 371A is formed between the top electrode 260 and the second piezoelectric layer 250, and the second air-ring 372A is formed between the second piezoelectric layer 250 and the middle electrode 240. In the depicted embodiment, the first air-ring 371A comprises an air-bridge 373 and an air-wing 377. The air-bridge 373 is located on the connection side of the top electrode 260 and the air-wing 377 is located along the remaining outside perimeter (around an outer perimeter of the top electrode 260). The second air-ring 372A does not include an air-wing since the air space formed by the second air-ring 372A is entirely enclosed within the acoustic stack 305A. The addition of a second air-ring to the acoustic stack 305A generally further increases the Q-factor of the RBAR device 300A, as compared to an RBAR with a single air-ring, while at least maintaining the desired coupling coefficient kt².

Notably, in the depicted embodiment, both of the first air-ring 371A and the second air-ring 372A are formed between layers at or above the second piezoelectric layer 250. Therefore, as in the case of a single air-ring discussed above, the first and second air-rings 371A and 372A, individually or collectively, do not reduce the parasitic transducer effect, as explained above with reference to FIGS. 2A and 2B. Thus, in order to reduce the parasitic transducer effect, each of the bottom electrode 220 and the middle electrode 240 of the RBAR device 300A is terminated over the cavity 215 (or other acoustic reflector) formed in the substrate 210, and is planarized. That is, each of the bottom electrode 220 and the middle electrode 240 ends within the outer edges 216 of the cavity 215.

Referring to FIGS. 3B and 3C, each of RBAR device 300B and RBAR device 300C includes substrate 210 defining cavity 215. Bottom electrode 220′ and adjacent planarization layer 225′ are formed over the substrate 210 and the cavity 215, first piezoelectric layer 230 is formed over the bottom electrode 220′ and planarization layer 225′, middle electrode 240′ and adjacent planarization layer 245′ are formed over the first piezoelectric layer 230, second piezoelectric layer 250 is formed over the middle electrode 240′ and the planarization layer 245′, and top electrode 260 is formed over the second piezoelectric layer 250, collectively forming acoustic stacks 305B and 305C, respectively. In each of the depicted embodiments, dielectric seed layer 247 is formed over the middle electrode 240′ and the planarization layer 245′, and the second piezoelectric layer 250 is grown on the dielectric seed layer 247 to reverse the polarity of the second piezoelectric layer 250. A passivation layer (not shown) may be formed over the top electrode 260 of the RBAR devices 300B and 300C.

In addition, the RBAR devices 300B and 300C include various performance enhancement features, including inner frame 262 and outer frame 264 provided on the top surface of the top electrode 260, as well as two air-rings. The RBAR device 300B includes first air-ring 371B, formed between the top electrode 260 and the second piezoelectric layer 250, and second air-ring 372B formed between the middle electrode 240′ (and the planarization layer 245′) and the first piezoelectric layer 230. The RBAR device 300C includes first air-ring 371C, formed between the top electrode 260 and the second piezoelectric layer 250, and second air-ring 372C formed between the first piezoelectric layer 230 and the bottom electrode 220′ (and the planarization layer 225′). The second air-rings 372B and 372C do not include an air-wing since the air spaces formed by the second air-rings 372B and 372C are entirely enclosed within the acoustic stacks 305B and 305C, respectively.

Notably, because each of the second air-ring 372B and the second air-ring 372C is formed between adjacent layers situated below the second piezoelectric layer 250, they reduce the parasitic transducer effect otherwise present in the corresponding RBAR devices, even though each of the first air-rings 371B and 371C are formed between layers at or above the second piezoelectric layer 250. Accordingly, there is no need for the middle electrode 240′ and/or the bottom electrode 220′ to end within the outer edges 216 of the cavity 215, and are therefore longer than the middle electrode 240 and the bottom electrode 220, respectively, discussed above (but otherwise have the same characteristics). Therefore, in the embodiments depicted in FIGS. 3B and 3C, no portion of the middle electrode 240′ and/or the bottom electrode 220′ ends within the outer edges 216 of the cavity 215. Again, extending the bottom electrode 220′ entirely across the cavity 215 (e.g., such that all outer edges of the bottom electrode 220′ are over and/or in physical contact with the top surface of the substrate 210) increases structural strength of the RBAR devices 300B, 300C, as well as increases heat transfer from the acoustic stack 305B, 305C to the substrate 210 of the RBAR devices 300B, 300C.

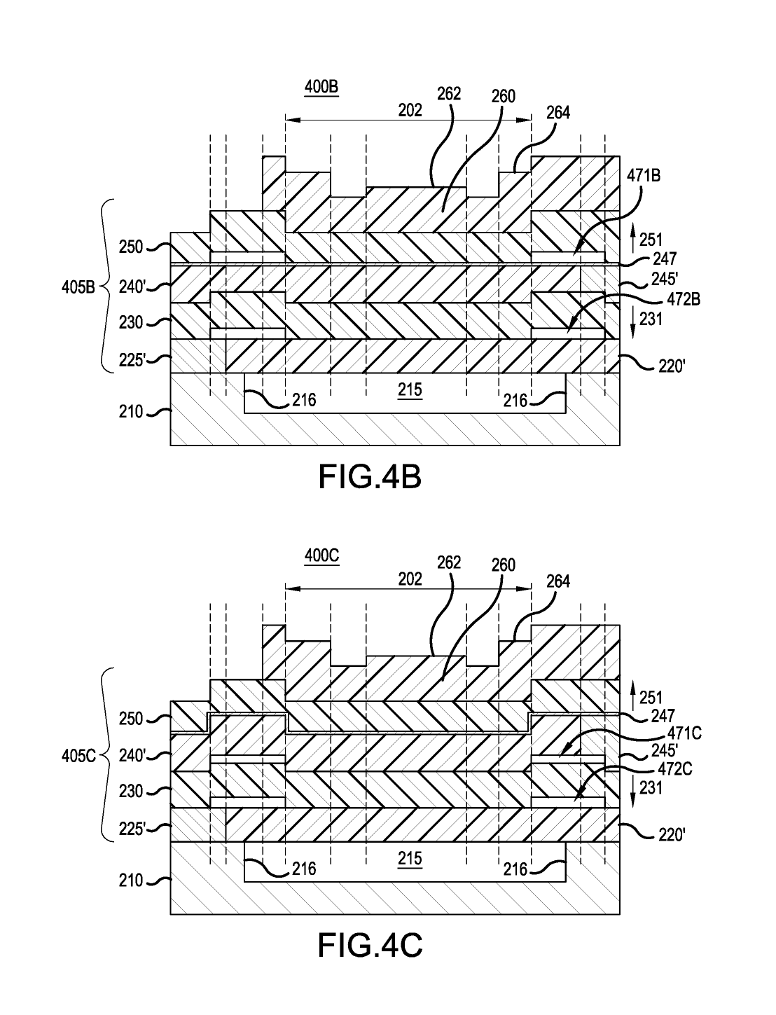

FIGS. 4A to 4C are simplified cross-sectional diagrams of RBAR devices with multiple air-rings, according to representative embodiments.

Referring to FIGS. 4A and 4B, each of RBAR devices 400A and 400B include substrate 210 defining cavity 215. Bottom electrode 220′ and adjacent planarization layer 225′ are formed over the substrate 210 and the cavity 215, first piezoelectric layer 230 is formed over the bottom electrode 220′ and planarization layer 225′, middle electrode 240′ and adjacent planarization layer 245′ are formed over the first piezoelectric layer 230, second piezoelectric layer 250 is formed over the middle electrode 240′ and the planarization layer 245′, and top electrode 260 is formed over the second piezoelectric layer 250, collectively forming acoustic stacks 405A and 405B, respectively. In each of the depicted embodiments, dielectric seed layer 247 is formed over the middle electrode 240′ and the planarization layer 245′, and the second piezoelectric layer 250 is grown on the dielectric seed layer 247 to reverse the polarity of the second piezoelectric layer 250. A passivation layer (not shown) may be formed over the top electrode 260.

The RBAR devices 400A and 400B include various performance enhancement features, including inner frame 262 and outer frame 264 provided on a top surface of the top electrode 260, discussed above. The RBAR device 400A further includes two air-rings, first air-ring 471A and second air-ring 472A. The first air-ring 471A is formed between the second piezoelectric layer 250 and the middle electrode 240′ (and the planarization layer 245′), and the second air-ring 472A is formed between the middle electrode 240′ (and the planarization layer 245′) and the first piezoelectric layer 230. The RBAR device 400B in FIG. 4B further includes first air-ring 471B and second air-ring 472B. The first air-ring 471B is formed between the second piezoelectric layer 250 and the middle electrode 240′ (and the planarization layer 245′), and the second air-ring 472B is formed between the first piezoelectric layer 230 and the bottom electrode 220′ (and the planarization layer 225′).

In the depicted embodiment, neither the first air-ring 471A, 471B nor the second air-ring 472A, 472B comprises an air-wing since the air spaces formed by the first air-rings 471A, 471B and the second air-rings 472A, 472B are entirely enclosed within the acoustic stacks 405A and 405B, respectively. The addition of second air-rings to the acoustic stacks 405A and 405B generally further increase the Q-factor of the RBAR devices 400A and 400B, as compared to an RBAR with a single air-ring, while at least maintaining the desired coupling coefficient kt².

Notably, in the depicted embodiment, the first air-ring 471A, 471B is formed above the middle electrode 240′, and the second air-ring 472A, 472B is formed below the middle electrode 240′. Therefore, because the second air-ring 472A, 472B is formed between adjacent layers situated below the second piezoelectric layer 250, it reduces the parasitic transducer effect otherwise present in the RBAR devices 400A and 400B, even though each of the first air-rings 471A and 471B is formed between layers at or above the second piezoelectric layer 250. That is, the first air-ring 471A, 471B is between the second piezoelectric layer 230 and the middle electrode 240′ (and planarization layer 245′), the second air-ring 472A is between the middle electrode 240′ (and planarization layer 245′) and the first piezoelectric layer 230, and the second air-ring 472B is between the first piezoelectric layer 230 and the bottom electrode 220′ (and planarization layer 225′). Accordingly, there is no need for the middle electrode 240′ and/or the bottom electrode 220′ to end within outer edges 216 of the cavity 215, and are therefore longer than the middle electrode 240 and the bottom electrode 220, respectively, discussed above (but otherwise have the same characteristics).

Referring to FIG. 4C, RBAR device 400C includes substrate 210 defining cavity 215. Bottom electrode 220′ and adjacent planarization layer 225′ are formed over the substrate 210 and the cavity 215, first piezoelectric layer 230 is formed over the bottom electrode 220′ and planarization layer 225′, middle electrode 240′ and adjacent planarization layer 245′ are formed over the first piezoelectric layer 230, second piezoelectric layer 250 is formed over the middle electrode 240′ and the planarization layer 245′, and top electrode 260 is formed over the second piezoelectric layer 250, collectively forming acoustic stack 405C. In the depicted embodiment, dielectric seed layer 247 is formed over the middle electrode 240′ and the planarization layer 245′, and the second piezoelectric layer 250 is grown on the dielectric seed layer 247 to reverse the polarity of the second piezoelectric layer 250. A passivation layer (not shown) may be formed over the top electrode 260 of the RBAR device 400C.

The RBAR device 400C includes various performance enhancement features, including inner frame 262 and outer frame 264 provided on the top surface of the top electrode 260. The RBAR device 400C further includes two air-rings, both of which are formed between adjacent layers situated below the second piezoelectric layer 250. That is, the first air-ring 471C, formed between the middle electrode 240′ (and the planarization layer 245′) and the first piezoelectric layer 230, and second air-ring 472C formed between the first piezoelectric layer and the bottom electrode 220′ (and the planarization layer 225′).

Because each of the second air-ring 472A in RBAR device 400A and the second air-ring 472B in the RBAR device 400B is formed between adjacent layers situated below the second piezoelectric layer 250, they can individually reduce the parasitic transducer effect that would otherwise be present. Likewise, because both of the first air-ring 471C and the second air-ring 472C in RBAR device 400C are formed between adjacent layers situated below the second piezoelectric layer 250, they can individually and/or collectively reduce the parasitic transducer effect otherwise present. Accordingly, there is no need for the middle electrode 240′ and/or the bottom electrode 220′ to end within the outer edges 216 of the cavity 215 in any of the RBAR devices 400A, 400B or 400C. The middle electrode 240′ and/or the bottom electrode 220′ are therefore longer than the middle electrode 240 and the bottom electrode 220, respectively, discussed above (but otherwise have the same characteristics). Therefore, in the embodiments depicted in FIGS. 4A to 4C, no portion of the middle electrode 240′ and/or the bottom electrode 220′ ends within the outer edges 216 of the cavity 215. Again, extending the bottom electrode 220′ entirely across the cavity 215 increases structural strength of the RBAR devices 400A, 400B and 400C, as well as increases heat transfer from the acoustic stack 405A, 405B, and 405C to the substrate 210.

In alternative embodiments of the RBAR devices 200A-200D, 300A-300C and 400A-400C may have an acoustic mirror, such as a distributed Bragg reflector (DBR) (not shown), as the acoustic reflector in place of the cavity 215, without departing from the scope of the present teachings. The DBR may be formed on the top surface of the substrate 210 or embedded within the substrate 210 in an area where the cavity 215 is shown. The DBR may include one or more sequentially stacked acoustic reflector layer pairs. Each of the stacked acoustic reflector layer pairs includes two layers, i.e., a first layer with a first acoustic impedance and a second layer with a second acoustic impedance stacked on the first layer. Within each acoustic reflector layer pair of the DBR, the first acoustic impedance is less than the second acoustic impedance. Thus, for example, the first layer may be formed of various low acoustic impedance materials, such as boron silicate glass (BSG), tetra-ethyl-ortho-silicate (TEOS), silicon oxide (SiOx) or silicon nitride (SiNx) (where x is an integer), carbon-doped silicon oxide (CDO), titanium (Ti) or aluminum, and each of the second conductive layers may be formed of various high acoustic impedance materials, such as tungsten (W), molybdenum (Mo), niobium molybdenum (NbMo), iridium (Ir), hafnium oxide (HfO2), aluminum oxide (Al2O3), diamond or diamond-like carbon (DLC). Various illustrative fabrication techniques of acoustic mirrors are described by Larson III, et al., U.S. Pat. No. 7,358,831 (issued Apr. 15, 2008), which is hereby incorporated by reference in its entirety.

Generally, the outer frame 264 formed on the top electrode 260 in the various embodiments discussed above has an inner perimeter that defines an active region 204 within the main membrane region 202. The outer frame 264 is positioned in an outer region of the top electrode 260, and the inner frame 262 is positioned in a center region of the top electrode 260. A frame may be formed by adding a layer of material, usually an electrically conducting material (although dielectric material is possible as well) to the top electrode (and/or to the middle and bottom electrodes). For example, the outer frame 264 may be formed by depositing additional material in the outer region and the inner frame 262 may be formed by depositing additional material in the center region of the top electrode 260 (main part of the acoustic resonator). The frame can be either a composite frame or an add-on frame. In the embodiments depicted herein, the frames are shown as add-on frames, for the sake of convenience, although composite frames may be included instead without departing from the scope of the present teachings. Examples of construction of various composite and add-on frames are provided by U.S. Patent App. Pub. No. 2014/0118087 to Burak et al., which is hereby incorporated by reference in its entirety.

A frame generally suppresses electrically excited piston mode in the frame region, and it reflects and otherwise resonantly suppresses propagating eigenmodes in lateral directions, with both effects simultaneously improving operation of the acoustic resonator. This is because the frame's presence generally produces at least one of a cutoff frequency mismatch and an acoustic impedance mismatch between the frame region and other portions of the active region. A frame that lowers the cutoff frequency in the frame region as compared to the active region may be referred to as a Low Velocity Frame (LVF), while a frame that increases the cutoff frequency in the frame region as compared to the main active region may be referred to as a High Velocity Frame (HVF).

A frame with lower effective sound velocity than the corresponding effective sound velocity of the active region (i.e., an LVF) generally increases parallel resistance Rp and Q-factor of the acoustic resonator above the cutoff frequency of the active region. Conversely, a frame with a higher effective sound velocity than the corresponding effective sound velocity of the active region (i.e., an HVF) generally decreases series resistance Rs and increases Q-factor of the acoustic resonator below the cutoff frequency of the main active region. A typical low velocity frame, for example, effectively provides a region with significantly lower cutoff frequency than the active region and therefore minimizes the amplitude of the electrically excited piston mode towards the edge of the top electrode in the frame region. Furthermore, it provides two interfaces (impedance miss-match planes), which increase reflection of propagating eigenmodes. These propagating eigenmodes are mechanically excited at active/frame interface, and both mechanically and electrically excited at the top electrode edge. Where the width of the frame is properly designed for a given eigenmode, it results in resonantly enhanced suppression of that particular eigenmode. In addition, a sufficiently wide low velocity frame provides a region for smooth decay of the evanescent and complex modes, which are excited by similar mechanisms as the propagating eigenmodes. The combination of the above effects yields better energy confinement and higher Q-factor at a parallel resonance frequency Fp.

Various additional examples of frames, as well as related materials and operating characteristics, are described in U.S. Pat. No. 9,401,692 to Burak et al. (issued Jul. 26, 2016) and U.S. Pat. No. 9,425,764 to Burak et al. (issued Aug. 23, 2016), which are hereby incorporated by reference in their entireties. As explained in those applications, frames can be placed in various alternative locations and configurations relative to other portions of an acoustic resonator, such as the electrodes and piezoelectric layer of an acoustic stack. Additionally, their dimensions, materials, relative positioning, and so on, can be adjusted to achieve specific design objectives, such as a target resonance frequency, series resistance Rs, parallel resistance Rp, or electromechanical coupling coefficient kt². Although the following description presents several embodiments in the form of FBAR and SMR devices, several of the described concepts could be implemented in other forms of acoustic resonators.

As discussed above, the outer frame 264 has inner edges that define a boundary of the active region 204 formed within the main membrane region 202. As should be appreciated by one skilled in the art, the outer frame 264 forms an effective Low Velocity Frame, and the region between the outer edge of inner frame 262 and the inner edge of outer frame 264 forms an effective High Velocity Frame discussed above. The outer edges of the outer frame 264 may define the outer edges of the main membrane region 802, and may coincide with the inner edges of the air-ring 270A in FIG. 2A, for example (as well as inner edges of the various air-rings in the other embodiments).

Also, in alternative embodiments, the RBAR devices 200A-200D, 300A-300C and/or 400A-400C may have fewer than all of the lateral enhancement features shown, without departing from the scope of the present teachings. For example, a RBAR device may have inner frames and no outer frames, or outer frame but no inner frames.

In addition, the representative RBAR devices 200A-200D, 300A-300C and/or 400A-400C may include a temperature compensating feature having a positive temperature coefficient for offsetting at least a portion of negative temperature coefficients elsewhere in the RBAR device. Temperature compensating features may include a temperature compensating layer in one or more of the bottom, middle and top electrodes, for example. The temperature compensating layer may be formed of an oxide material, such as boron silicate glass (BSG), for example, having a positive temperature coefficient which offsets at least a portion of negative temperature coefficients of the first and/or second piezoelectric layers, and the conductive material in the bottom, middle and top electrodes. As used herein, a material having a “positive temperature coefficient” means the material has positive temperature coefficient of elastic modulus over a certain temperature range. Similarly, a material having a “negative temperature coefficient” means the material has negative temperature coefficient of elastic modulus over the (same) certain temperature range. Various illustrative temperature compensating features are described by Burak et al., U.S. Patent App. Pub. No. 2014/0118092 (published May 1, 2014), which is hereby incorporated by reference in its entirety.

One of ordinary skill in the art would appreciate that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. A reversed c-axis bulk acoustic resonator (RBAR) device, comprising:
a bottom electrode disposed over a substrate and at least a portion of a cavity formed in the substrate;
a first piezoelectric layer disposed over the bottom electrode, the first piezoelectric layer having a first polarity;
a middle electrode disposed over the first piezoelectric layer;
a second piezoelectric layer disposed over the bottom electrode, the second piezoelectric layer having a second polarity that is substantially opposite to the first polarity of the first piezoelectric layer;
a top electrode disposed over the second piezoelectric layer; and
a first air-ring formed between the top electrode and the second piezoelectric layer, between the second piezoelectric layer and the middle electrode, between the middle electrode and the first piezoelectric layer, or between the first piezoelectric layer and the bottom electrode.

2. The RBAR device of claim 1, wherein the first air-ring is formed between the top electrode and the second piezoelectric layer, the first air-ring comprising an air-bridge and an air-wing.

3. The RBAR device of claim 1, wherein the first air-ring is formed between the second piezoelectric layer and the middle electrode.

4. The RBAR device of claim 1, wherein the first air-ring is formed between the middle electrode and the first piezoelectric layer.

5. The RBAR device of claim 4, wherein no portion of the middle electrode, forming the first air-ring, ends within outer edges of the cavity, thereby reducing parasitic transducer effect, and
wherein no portion of the bottom electrode ends within outer edges of the cavity, thereby increasing structural strength and increasing heat transfer to the substrate.

6. The RBAR device of claim 1, wherein the first air-ring is formed between the first piezoelectric layer and the bottom electrode.

7. The RBAR device of claim 6, wherein no portion of the middle electrode, forming the first air-ring, ends within outer edges of the cavity, thereby reducing parasitic transducer effect, and
wherein no portion of the bottom electrode ends within outer edges of the cavity, thereby increasing structural strength of the RBAR device and increasing heat transfer to the substrate.

8. The RBAR device of claim 1, further comprising:
a dielectric seed layer formed over the middle electrode, wherein the second piezoelectric layer is grown on the dielectric seed layer,
wherein the first piezoelectric layer has a negative polarity and the second piezoelectric layer has a positive polarity.

9. The RBAR device of claim 1, further comprising:
a dielectric seed layer formed over the bottom electrode, wherein the first piezoelectric layer is grown on the dielectric seed layer,
wherein the first piezoelectric layer has a positive polarity and the second piezoelectric layer has a negative polarity.

10. The RBAR device of claim 1, further comprising:
a second air-ring formed between adjacent layers that are below the first air-ring.

11. The RBAR device of claim 10, wherein the first air-ring is formed between the top electrode and the second piezoelectric layer, the first air-ring comprising an air-bridge and an air-wing, and
wherein the second air-ring is formed (i) between the second piezoelectric layer and the middle electrode, (ii) between the middle electrode and the first piezoelectric layer, or (iii) between first piezoelectric layer and the bottom electrode.

12. The RBAR device of claim 10, wherein the first air-ring is formed between the second piezoelectric layer and the middle electrode, and
wherein the second air-ring is formed (i) between the middle electrode and the first piezoelectric layer or (ii) between first piezoelectric layer and the bottom electrode.

13. The RBAR device of claim 12, wherein no portion of the middle electrode ends within outer edges of the cavity, and
wherein no portion of the bottom electrode ends within outer edges of the cavity, thereby increasing structural strength of the RBAR device and increasing heat transfer to the substrate.

14. The RBAR device of claim 10, wherein the first air-ring is formed between the middle electrode and the first piezoelectric layer, and
wherein the second air-ring is formed between the first piezoelectric layer and the bottom electrode.

15. The RBAR device of claim 14, wherein no portion of the middle electrode ends within outer edges of the cavity, and
wherein no portion of the bottom electrode ends within outer edges of the cavity, thereby increasing structural strength of the RBAR device and increasing heat transfer to the substrate.

16. The RBAR device of claim 1, further comprising:
an outer frame positioned in an outer region of the top electrode, the outer frame having an inner perimeter that defines an active region of the RBAR device.

17. The RBAR device of claim 16, further comprising:
an inner frame positioned in a center region of the top electrode.

18. A reversed c-axis bulk acoustic resonator (RBAR) device, comprising:
a bottom electrode disposed over a substrate and at least a portion of an acoustic reflector;
a first piezoelectric layer disposed over the bottom electrode, the first piezoelectric layer having a first polarity;
a middle electrode disposed over the first piezoelectric layer;
a second piezoelectric layer disposed over the bottom electrode, the second piezoelectric layer having a second polarity that is substantially opposite to the first polarity of the first piezoelectric layer;
a top electrode disposed over the second piezoelectric layer;
a first air-ring formed (i) between the top electrode and the second piezoelectric layer, (ii) between the second piezoelectric layer and the middle electrode, (iii) between the middle electrode and the first piezoelectric layer, or (iv) between the first piezoelectric layer and the bottom electrode; and
a second air-ring formed (i) between the second piezoelectric layer and the middle electrode, (ii) between the middle electrode and the first piezoelectric layer, or (iii) between first piezoelectric layer and the bottom electrode.

19. The RBAR device of claim 18, wherein the acoustic reflector comprises an air-cavity formed in the substrate.

20. The RBAR device of claim 18, wherein the acoustic reflector comprises a distributed Bragg reflector (DBR) embedded within the substrate.
